(19) United States
(12) Patent Application Publication
(10) Pub. No.: US 2015/0081330 A1
(43) Pub. Date: Mar. 19, 2015

(54) Medicant Dispensing System and Method

(71) Applicants: Howard Mann, Toronto (CA); Rick Macartney, Thornhill (CA); Lee Durst, Newport Beach, CA (US)

(72) Inventors: Howard Mann, Toronto (CA); Rick Macartney, Thornhill (CA); Lee Durst, Newport Beach, CA (US)

(73) Assignees: Howard Mann, Toronto (CA); DC NETCAST MEDIA GROUP, INC., Toronto (CA); Lee Durst, Newport Beach, CA (US); Rick Macartney, Thornhill (CA)

(21) Appl. No.: 14/030,925

(22) Filed: Sep. 18, 2013

(51) Int. Cl. G06F 19/00

(52) U.S. Cl. CPC G06F 19/3456
USPC 705/3

(57) ABSTRACT

Embodiments describe a medicant prescribing system, where the prescribing of the medicant is carried out on to a smart card, and where the prescribing is a suggestion without complete specificity of the medicant or its quantities. The card is used to obtain the medicant, and to monitor types and quantities of the medicant both and the quantities of the medicant. An embodiment requires using the card to obtain the medicant, since the prescription has been placed on or otherwise associated with the card. Another aspect requires monitoring the medicant card to monitor the actions at multiple different medicant sources, while using information on the card to pay for the medicant. One aspect forces patients to use the card in order to purchase.

An embodiment uses intelligence in the card to allow the card to be used offline, but synchronize with a database. An embodiment enforces synchronization at specified intervals.

### BACKGROUND

Different kinds of nonfood medicants are controlled in different ways. Some medicants, such as intoxicants, are controlled by age. For example, alcohol can be purchased by anyone of the proper age, and typically there is no limit on the amount of alcohol that one can purchase. There typically is no tracking or any other kind of information stored about the way alcohol is purchased.

Other medicants, which could be thought of as over-the-counter pharmaceuticals, are also typically unmonitored.

However, some over-the-counter pharmaceuticals, which can be used as byproducts for some other kind of drug manufacture are monitored. A patient needs to show a driver's license to purchase the item(s), and the amount of the item that the patient gets is also monitored.

Prescription drugs are monitored in various ways. Some drugs called controlled medicants are highly monitored, while other drugs only require a prescription. In the United States, the Medical Industry operates with procedures that are established and regulated by the American Medical Association (AMA) to prevent over medication and abuse.

Prescriptions are usually handled by a doctor or assistant who writes a prescription, a Pharmacist fills the prescription, with limited refills before the patients visits the Doctor for a re-examination and/or new prescription. Medicant is dispensed according to the prescription administered by the Specialist to affect the particular condition for which the patient was originally referred. Prescription drugs are exactly specified by the prescriber, including the amount, the dosage, and the specific drug that is used.

### SUMMARY

Embodiments describe a medicant prescribing system that uses a personal identification device to allow users to purchase and, in one embodiment pay for, medicant that was prescribed.

In one embodiment the prescribing of the medicant is carried out on to a smart card, and where the prescribing is a suggestion of what is to be obtained, without complete specificity of the medicant or its quantities. The card is used to obtain the medicant, and to monitor types and quantities of the medicant both and the quantities of the medicant. An embodiment requires using the card to obtain the medicant, since the prescription has been placed on or otherwise associated with the card.

The card can be a smart card, or can be a barcoded card where the intelligence resides in a remote database, or the card can be a phone or tablet, using an application or other information in the phone.

Another aspect requires monitoring the medicant card to monitor the actions at multiple different medicant sources, while using information on the card to pay for the medicant.

Another aspect includes a prescription for a medicant given by a medical professional that provides patient discretion as part of filling the prescription, but monitors the way in which the prescription is filled, and stores information as part of a database. This system and method can provide a prescription with some leeway in the prescription, and can keep track of what the patient actually buys using that prescription.

Another aspect forces patients to use the card in order to purchase. By forcing the patients to use the card, this can find out what part of the prescription was used, and how much was used and how the user changed it. An embodiment uses intelligence in the card to allow the card to be used offline, but eventually synchronize with a database.

An embodiment enforces synchronization at specified intervals, preventing the card from being used if synchronization is not carried out at those intervals.

### BRIEF DESCRIPTION OF THE DRAWINGS

in the drawings:

FIG. 1 shows a block diagram of the system; and

FIG. 2 shows an architecture of the client/server operation.

### DETAILED DESCRIPTION

Certain other kinds of medicants are regulated, prescribed and monitored differently than the different medicants described above. One of the medicants is medical marijuana. Some states such as California have legalized medical marijuana under certain circumstances. However, the inventors of this application have recognized problems with the dispensing of special medicants such as medical marijuana, that are addressed in this application.

As explained herein, these problems may also occur with other kinds of medicants that are prescribed, or may be otherwise regulated. For example, different kinds of previously illegal drugs can be legalized as the government realizes that the war on drugs can be very costly.

Other drugs or pseudo-drugs can also be medicants, when they are intended to have little or no ongoing supervision by a medical professional; however it may be desirable to monitor the totality of the use. One of these examples of this kind of drug is human growth hormone or HGH.

Despite the fact that the state of California has made medical marijuana legal, clinics have been prevented from conducting business with banks, to establish bank or merchant accounts to accept credit and debit cards as payment by patients. This means that the industry is forced to works on a cash basis. Because it remains a cash business, transactions can remain largely unreported.

Medicants of this type are prescribed differently by the medical profession. Right now, medical professionals do not provide leeway on the type of the drug (“species” or “strain”) or length of time of the drug. For example, it would not be proper for a medical professional to prescribed an “opiate” for back pain, and to allow patient to take as many as they want.

The present application teaches this different way of prescribing, where the patient is given authorization on an identification card to obtain a medicant, and may be given guidance on species, or strain, about the medicant. While the patients are given discretion in how to use the medicant, the prescription can be associated with the card, so that the patient is forced to use the electronic card in order to fill the prescription. When the patient uses the card to fill the prescription, the patient's actions can be monitored, thereby providing information about what the patient actually did when they filled the prescription.

Embodiments describe ways of prescribing, using the same card that is used for prescribing for also purchasing, and using the same card/system that is used for purchasing for monitoring patient activities.

The embodiments refer to a card, which can be an electronic card such as a smart card which itself stores information. However, this can be any kind of card, and can be for example an identification card or the like. The card can be a smart card, or can be a barcoded card where the intelligence resides in a remote database, or the card can be a phone or tablet, using an application or other information in the phone. For example, the phone can use a “wallet” type app, or a special app, or any other type system.

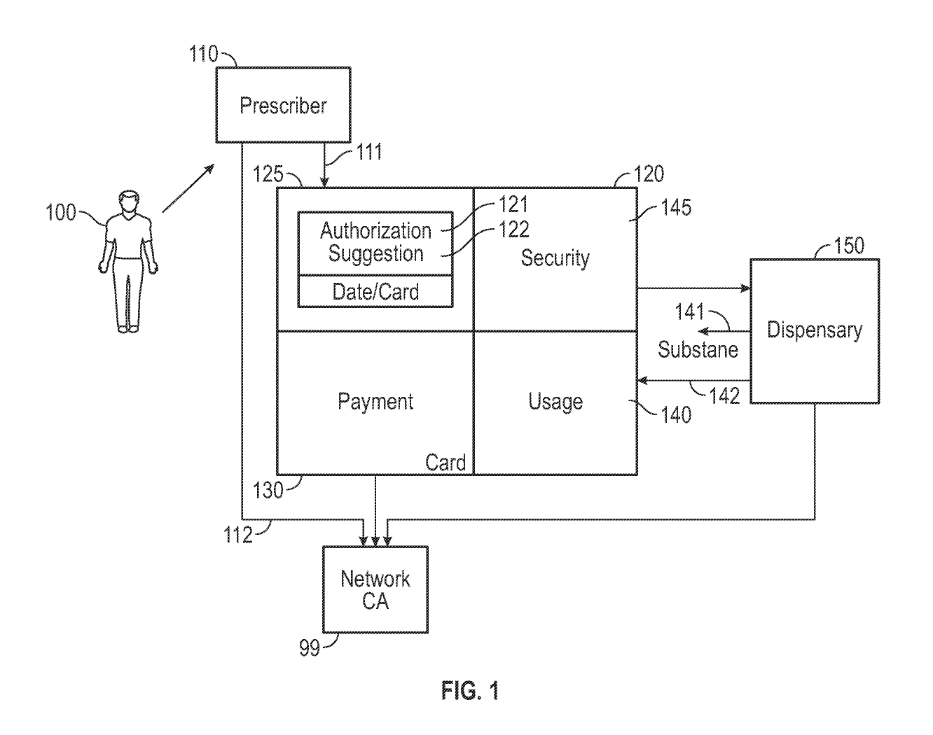

An embodiment, showing the flow of the operation is illustrated in FIG. 1. This embodiment is used for the operations described herein. A patient, 100 who has a medical condition first needs to seek advice from a prescriber. The prescriber can be for example a doctor, or a clinic, or the like. The prescriber 110 diagnoses the patient 100, and based on the diagnosis, provides information about a medicant to be given to the patient.

The prescriber 110 then provides the authorization 111 to obtain the medicant to a special card 120 of the type described above. When the card does not itself have intelligence, the prescription information is also provided to a central database shown as 112. The prescription information may in any case be provided directly to that database, or the card can provide the prescription information to the database during a synchronization.

According to an embodiment, the card 120 is a smart card which has electronics including a memory that stores information therein including the information 111 provided by the prescriber. The information 111 may include authorization for Medicant, shown as 121, as well as a suggestion of a specific type of Medicant that should be used. For example, in the case where there are different forms or types of Medicant, the suggestion may provide guidance on the kind of Medicant that should be used. Note however the difference between this and a basic medical prescribing system, where the latter is much more specific, and does not simply provide guidance but allow the user to try different forms of the medication in order to see which one works the best. Since this kind of medicant system allows user improvisation, there are special advantages from monitoring what the user actually does after receiving the prescription.

The patient may either have the card 120, or may be given the card by the prescriber 110. The card may include appropriate encryption so that it cannot be “hacked”. For example, the prescriber may sign cryptographically both the authorization and the suggestion or may cryptographically sign only some parts. The cryptographic signature is made in a way such that the cryptographic signature can be verified by the dispenser 150 as being legitimate, but patients without the cryptographic signature will not be able to provide the authorization. For example, the cryptographic signature can be a hash value added to the authorization, that uses a one-way function that can be easily verified as being authentic. An alternative uses a private/public key encryption system, where the prescriber 110 encrypts using their private key, but anyone can verify that key is authentic using the public key.

Another embodiment operates to require verification of the prescription using the connection to the network computer 99 before dispensing.

This embodiment does not allow off-line use of the card, but does not require cryptography.

In an alternative embodiment, the prescriber 110 writes a prescription for the patient who takes it to the dispenser 150 where the medicant is dispensed as prescribed. In one embodiment, the prescription can have limited refills before returning to the prescriber 110 for a re-examination and/or new prescription.

Various other information can also be provided, including dates and other information. The information provided by the prescriber is shown generally as 125, stored in a memory in the card 120 (or in the alternative embodiment in a memory within the network computer 99).

The card 120 may also include other information, and although that other information is shown separately, it may be stored in the same memory. Other information that is stored can include payment information, 130, which can be a prepaid authorization that is obtained by a user by paying money into an account maintained under control of the network computer 99. Alternatively, this can be a credit line, secured against either a credit card or general credit. As another alternative, the payment information 130 can be a cryptographic currency such as bitcoin. When the card 120 has intelligence (smart card or phone), a wallet-style app can be used.

Usage information can also be stored as 140, and this usage information is stored by the system at the time when the patient actually uses the card to obtain Medicant.

The card is then taken by the patient 100 to the dispensary 150. The dispensary checks the authorization, either by checking cryptographically the authorization 121 or checking the authorization on a network based central authorization server 99 or by using the written prescription. Upon detecting the proper use, the dispensary returns or allows the patient to purchase based on the authorization 121. The actual medicant that is purchased shown generally as 141 is given to the patient 100. At the same time, information about the specific Medicant that has been purchased, both quantity and specifics of the details, are stored into the usage area 140 of the card 120. That usage information is also synchronized, either at the time of purchase, or at some later time, in the central authorization computer 99. In one embodiment, synchronization every period of use is required, for example synchronization is required once a week or the card is rendered unusable to purchase more medicant until the synchronization is carried out. This enforces getting the information to the central authorization computer on a regular basis.

For example, this allows off-line usage of the card 120, since the card will be later synchronized to the central network database. The information that is sent to the database may include the suggestion 122, along with the actual usage information. The central database then obtains information about what users actually did which can be stored as a function of the suggestion that was given, or as a function of the medical condition that led to the prescribing of the medicant. When the user goes back to the dispensary again at some later time, the information is again obtained. This forms a trend which indicates what the user does. For example if the user buys the same species of medicant multiple times, this may indicate that the species is working well for the user.

In one embodiment, the card may also store various kinds of security information such as 145. The security information, for example, can include information about how long it has been since the card 120 communicated directly to the network authorizer. The communication to the network authorizer make sure that the card has not been hacked or otherwise interfered with, and that the information is up-to-date, including that the usage information in 140 has been communicated to the network authorization, and that the payment information 130 has been appropriately backed up.

According to one embodiment, the payment information can be prepaid data that is stored in the payment information 130. This can also be a credit account, that either directly debits against credit or debit cards, or does so through an intermediary, thus allowing credit card access via the intermediary.

The prescribing at 110 starts with the patient's Doctor, who can either prescribe directly or recommend the patient to a Specialist, providing the Specialist with the patient's medical history whereupon the Specialist reviews and determines appropriate treatment.

Once it is determined that the patient qualifies for medicant, an account, here a “CalKard” account is created to facilitate the treatment prescribed by the Specialist for the patient, including weekly limits, specific strains of medicant for particular ailments, and a feedback loop for the Specialist to monitor and provide further recommendations based on industry results and averages tracked and reported by CalKard's patients.

CalKard software, running on the network computer 99, ties all patient data and sales reporting functions together, in order to operate safely within Federal and State regulations.

Medicine is sold through a dispensary 150 with a closed series of medicants. The medicants sold through the dispensary can include medical marijuana, anti-aging, weight-loss, HGH and others, and will only be dispensed by a licensed Pharmacist or Pharmatech on duty.

One medicant can be Hormone 6 therapies, such as HGH that have been forecast to grow into a $150 Billion a year segment within 3-years.

Around the age of 30 our production of HGH, a common term for human growth hormone, which is not only responsible for height development in children and teens but for cell regeneration throughout the body, begins to decline. Declining HGH translates into slower recovery from injuries and the daily damage we sustain our body is simply not replacing damaged cells as comprehensively as it did in our youth. If levels of HGH are low replacing HGH can have great antiaging benefits, including:

Improvement in lean muscle mass and strength

Decreased ratio of fat to muscle, especially in the abdomen

More youthful skin due to increased elasticity and blood flow

Decreased healing time from injuries

Elevated mood, sense of calm, well-being

Restoration of liver and kidney size and function

The body does continue to produce HGH even after its levels begin to decline in adult life, but usually in short bursts during deep sleep, intense exercise, and when the hormone Insulin is low.

Although HGH does not arrest the aging process altogether, it can suppress the symptoms of aging. Many people take HGH when experiencing symptoms of decreased cardiac function, a decrease in muscle or bone density, an increase in central body fat, depleted or decreased immune function, a decrease in energy, drive, and motivation levels, mood swings, and a decrease in sexual drive or function.

Use of the CalKard stores information into the central database 99. The Calkard software also provides a patient administration system that ties together prescriptions with patient consumption, as well as sales reporting and industry monitoring. This can also protect against abuse. For example, in one embodiment, the dispensaries 150 break down medicine into weekly amounts that Pharmatechs can dispense.

In one embodiment, the central database 99 verifies the patient's prescription, including type of medicine, weekly/monthly quantity to be dispensed, and the current status of the patient's medication received as a percentage of the maximum allowed per week/month.

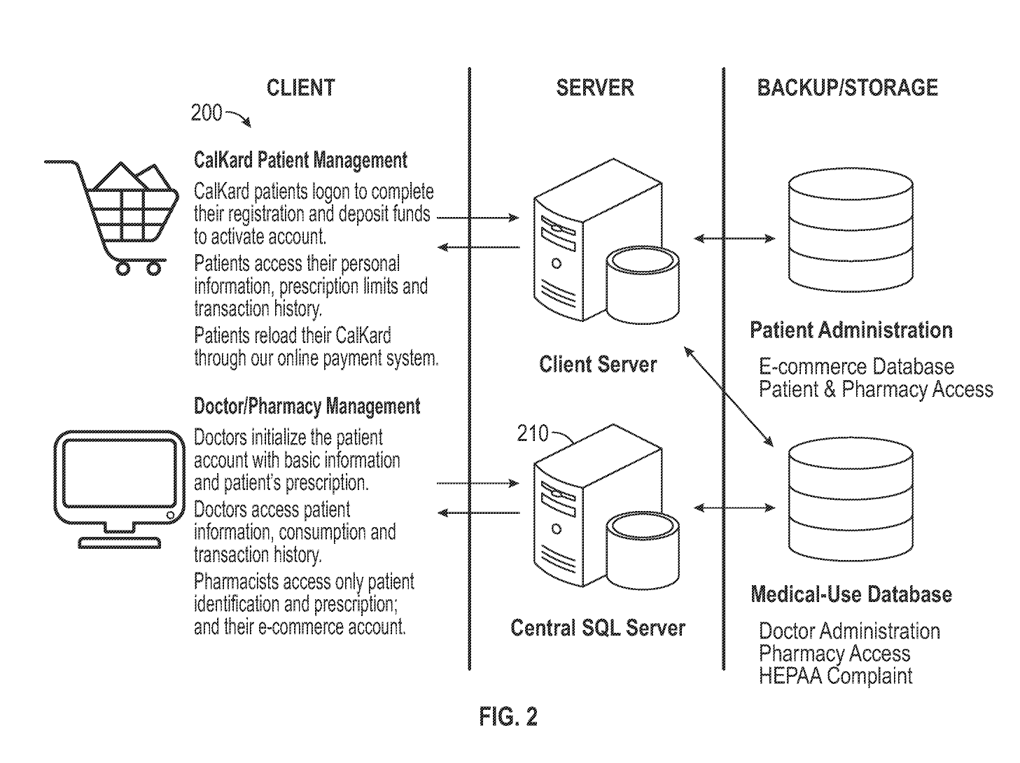

The CalKard software includes a management system 200 shown in FIG. 2. This provides different information for each of the Patient, Doctor, and pharmacist.

Patient management system 200 allows the patient to see prescription information, including limits, expiration dates, account balance, and medicine consumption balance.

Doctors are able to see patient medical history, treatments, limits, consumption and trended results. The doctor's platform also links to the appropriate ICD (international classification of Diseases) and provides the applicable range of codes for the doctor to assign and properly classify the patient.

Pharmacists/Dispensers are able to see the patient's prescription along with consumption patterns and available balance; plus their own e-account balance.

In one embodiment, the card is obtained when the patient logs on, complete a registration via certain kinds of information on the computer 99, and adds a funding source. Patients can reload the funding as necessary. Personal information is added.

The doctors and pharmacies initialize the patient account with basic information.

CalKard utilises a unique patient identification code to access an SQL database 210 that stores personal data, account balances, transactional volume, research data and patient management tools. The database is accessible by the patient, prescriber or dispensary, and is used to monitor the individual patient. Treatment recommendations and medicine efficacy through a constant feedback loop that compares the Doctor's recommendation with actual treatment results to optimize and improve future patient care.

A patient visits a CalKard-licensed doctor to receive a medical examination. To being the process, the doctor visits the “Prescription Issuance” section of the Doctor Portal” on the CalKard Website. This section requires the doctor to fill out the required information, including the patient's desired CalKard PIN, and take a photo of the patient. Upon successful entry, the doctor is given the ability to issue and print the patient's CalKard or to provide electronic authorization to an electronic card.

In one embodiment, the CalKard photo ID card is given to the patient with a unique patient identifier, medicine prescribed, weekly limits, and the renewal date provided by the prescriber 110. The patient goes online using their unique identification information to complete the CalKard application forms and deposit funds from their credit card to enable the card to purchase medicine. Once at the dispensary 150, the pharmacist swipes the patient's CalKard to read the data that is limited to the patient's prescription, and fulfills the order based on current status and funds available.

Each time a patient goes online to move funds from their credit card to their CalKard and prepare to purchase more medicine, they are asked for their feedback on recent treatment and product results with the intention of monitoring those results along with other patients with similar symptoms. In one embodiment, the information can be also given to test labs associated with making or distributing the medicant to allow those test labs to get more information about the medicant.

Upon any re-examination by the prescriber, the patient's results are compared with industry averages from all CalKard patients with an ability to make adjustments to their prescription for improved patient care.

Another embodiment allows the online credentials to be used for the patients to shop online.

In order to obtain the maximum effectiveness, CalKard-licensed dispensaries 150 will require the CalKard for every purchase. One embodiment can require that all payments use the CalKard. In that embodiment, once a patient is issued a CalKard, the patient must load the card with funds in order to make purchases. Card loading will be performed through the “Add Funds” section of the [password-protected] “Patient Portal.” Card loads will be available in predetermined denominations ($20, $40, $100, etc.) and transacted via ACH; this will results in a 1 (most cases) to 2 business day lead time before the respective funds become available in the patient's account for purchasing.

Online purchasing allows the Patients to make purchases through the CalKard Website via their Patient Portal. Once a patient logs in, they select the “Make a Purchase” section at which point the Website shows the available inventory from the dispensaries that service the patient's territory (geo-located by the zip code in the patient's account profile). Similar to any other e-commerce Website, the patient can add various items to a shopping cart and check out using their CalKard Identification #, expiration date, and PIN, similarly to how one uses a credit card to make purchases. Patients can also choose whether or not to have the shipment home-delivered or be notified when the order is available for pickup at the dispensary (the latter requiring identification and order# when picking up).

In-store purchases that were not pre-bought on the CalKard Website require use of the physical CalKard for the purchase. The Calkard Pharmacy System uses a computer connected to the internet, and a reader for the CalKard device. When a customer picks up a pre-bought order or desires to make an in store purchase, the pharmacist will log on to the [password-protected] “Pharmacy Portal” of the CalKard Website to complete the transaction. In the case of a prebought order, the pharmacist verifies the customer's CalKard, ID and order number, them marks the order as “picked up.”

In the case of in-store purchases, the pharmacist completes within the Pharmacy Portal a simplified purchase/check-out procedure. In this situation, the pharmacist must swipe the CalKard using the provided card reader in order to complete the transaction.

In one embodiment, the physical CalKard is similar to a driver's license in appearance. The front has identifying information such as the patient's name, photo, date of expiration (if any) and CalKard identification number. The rear side contains a magnetic stripe which also contains the patient's name, date of expiration (if any), and CalKard identification number (which is secure encoded). CalKard identification numbers are pre-printed on the card stock for inventory purposes and to deter fraudulent use. Additionally, each card is pre-printed with holographic images to deter card duplication and counterfeiting.

Other embodiments provide intelligence, e.g., electronics in the card.

According to another embodiment, the card and its use incorporate a rewards program whereby customers can accumulate points tied to each dollar they spend through the CalKard. These points can then be used to offset the cost of future purchases or to obtain rewards of some other type.

Another aspect requires monitoring the medicant card to monitor the actions at multiple different medicant sources to obtain those points.

Another embodiment may store information in the card about the specific Medicant that is available from different dispensaries. In this case, the prescriber 110 may ask what dispensary the patient prefers. At that point, the prescriber can determine what the options are for that dispensary, and store that is part of the suggestions 122. Then the information which is stored in the card may include information such as patient x was suggested to obtain Medicant VI, and patient x tried VI, but eventually used more of v2 then they used of VI. This kind of information is accumulated by the central server 99.

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art. For example, other kinds of medicants can be dispensed using this system in this card. Moreover, other kinds of cards can be used, and off-line systems are intended to be included.

The embodiments describe a “Calkard”, intended for use in California. However other cards and systems for other states can also be used and are intended to be encompassed within the invention. Moreover, a multistate version may be intended to be encompassed.

Also, other forms and types of the card are encompassed.

Those of skill would further appreciate that the various illustrative logical blocks, modules, circuits, and algorithm steps described in connection with the embodiments disclosed herein may be implemented as electronic hardware, computer software running on a specific purpose machine that is programmed to carry out the operations described in this application, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be implemented or performed with a general or specific purpose processor, or with hardware that carries out these functions, e.g., a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, micro controller, or state machine. The processor can be part of a computer system that also has an internal bus connecting to cards or other hardware, running based on a system BIOS or equivalent that contains startup and boot software, system memory which provides temporary storage for an operating system, drivers for the hardware and for application programs, disk interface which provides an interface between internal storage device(s) and the other hardware, an external peripheral controller which interfaces to external devices such as a backup storage device, and a network that connects to a hard wired network cable such as Ethernet or may be a wireless connection such as a RF link running under a wireless protocol such as 802.11. Likewise, external bus 18 may be any of but not limited to hard wired external busses such as IEEE-1394 or USB. The computer system can also have a user interface port that communicates with a user interface, and which receives commands entered by a patient, and a video output that produces its output via any kind of video output format, e.g., VGA, DVI, HDMI, displayport, or any other form. This may include laptop or desktop computers, and may also include portable computers, including cell phones, tablets such as the IP ADTM and Android platform tablet, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer system that controls and monitors delivering medicant to a patient comprising:
a computer, having a connection on a network,
said computer receiving first information responsive to a first patient gets a prescription for medicant, where said first information comprises both a prescription and also comprises a recommendation of a strain of medicant to obtain as part of the prescription;
said computer receiving second information responsive to the first patient uses the prescription to obtain the medicant, said second information including information about a strain of the medicant that was obtained based on the prescription and a quantity of the medicant that was obtained based on the prescription, where the strain of medicant that is obtained is different than the strain provided as said recommendation.

2. The computer system as in claim 1, wherein said computer connects over the network to a remote computer that reads a card from the first patient.

3. The computer system as in claim 1, wherein the computer obtains information from multiple different sources of medicant.

4. The computer system as in claim 1, wherein the medicant is medical marijuana.

5. The computer system as in claim 1, wherein the medicant is human growth hormone.

6. The computer system as in claim 1, wherein the prescription has been associated with an account associated with a card held by the patient, and the computer verifies the prescription.

7. The computer system as in claim 6, wherein the patient uses the card to purchase the medicant, where the computer verifies and handles payments that are on the card.

8. The computer system as in claim 7, wherein the computer provides a first information for a patient indicating a balance on their account that is available to purchase medication, a second information for a doctor that provides patient medical history and results, and a third information for a provider of medicant that provides different information than said first information or said second information.

9. A method of receiving a prescription of medicant by a patient, comprising:
the patient receiving a prescription for medicant;
the patient filling the prescription for medicant, using a special card that is validated from the same source that provides prescription,
when filling the prescription, information about a specific medicant that has been obtained as part of the prescription being used as part of filling the prescription and being sent over a network to a remote device; and
where the information comprises a strain of the medicant, and where the prescription allows different strains of medicant to be obtained with the prescription, where said information including a strain of the medicant that was obtained based on the prescription and a quantity of the medicant that was obtained based on the prescription.

10. The method as in claim 9, wherein the prescription includes a recommendation for a specific strain of medicant, and where the strain of medicant that is obtained is different than the strain provided as said recommendation.

11. The method as in claim 9, further comprising connecting over the network to a remote computer and providing information from said card to the remote computer.

12. The method as in claim 9, wherein the medicant is medical marijuana.

13. The method as in claim 9, wherein the medicant is human growth hormone.

14. The method as in claim 9, wherein the receiving the prescription comprises obtaining an electronic authorization using the card.

15. The method as in claim 14, further comprising connecting over the network to a remote computer and providing information from said card to the remote computer, wherein the remote computer verifies the prescription associated with the card.

16. The method as in claim 15, wherein the patient uses the card to purchase the medicant, where the remote computer verifies and handles payments that are carried out using the card.

17. The method as in claim 11, further comprising obtaining the medicant without a connection to the remote computer, and subsequently synchronizing to the remote computer by providing information about the medicant to the remote computer at a time after obtaining the medicant.

18. A computer system that monitors delivering of medicant to a patient comprising:
a computer, having a connection on a network,
said computer receiving first information when a first patient gets a prescription for medicant, where said first information comprises both a prescription and also comprises a recommendation of a strain of medicant to obtain as part of the prescription;
said computer receiving second information when the patient uses the prescription to obtain the medicant at a dispensing source, by obtaining card information that is read from a personal card that is associated with the patient, said second information including information about a strain of the medicant that is obtained based on the prescription, which can be the same as or different than the recommendation, and a quantity of the medicant that is obtained based on the prescription,
said computer checking a status of an account balance, and paying for the medicant by debiting the account balance when the account balance has sufficient funds to obtain the medicant that the patient is obtaining, and automatically storing quantity and strain of the medicant that was obtained, as part of a transaction, while automatically debiting the account balance.

19. The computer system as in claim 18, wherein the computer obtains information from multiple different dispensing sources of medicant.

20. The computer system as in claim 18, wherein the medicant is medical marijuana.

21. The computer system as in claim 18, wherein the medicant is human growth hormone.

22. The computer system as in claim 18, wherein the computer verifies the prescription on the card.

23. The computer system as in claim 18, wherein the computer provides a first information for a patient indicating a balance on their account that is available to purchase medication, a second information for a doctor that provides patient medical history and results, and a third information for a provider of medicant that provides different information than said first information or said second information.

24. A medicant prescribing system, comprising:
a card shaped device, having a part that is used for communicating with a remote database therein,
said card being used to obtain the medicant, and to monitor types and quantities of the medicant by using an electronic authorization obtained using the card at any of multiple different medicant sources, and
said card used to pay for the medicant using information stored on the card and read from the card to make payment
wherein both prescription information and payment information is obtained using the card.

25. The system as in claim 24, said card including a memory for storing information about a prescription for a medicant and a suggestion of what is to be obtained, without complete specificity of the medicant or its quantities,
wherein the card can be used offline, but must be synchronized with said database, and where the card cannot be used offline unless synchronization is carried out at specified intervals, preventing the card from being used if synchronization is not carried out at said intervals.

26. The system as in claim 24, wherein the medicant is medical marijuana.

27. The system as in claim 24, wherein the medicant is human growth hormone.

28. The system as in claim 25, wherein the database verifies the prescription on the card.
